(19) United States
(12) Patent Application Publication
(10) Pub. No.: US 2024/0176820 A1
(43) Pub. Date: May 30, 2024

(54) SYSTEMS AND METHODS FOR PROVIDING INTERACTIVE SUMMARY OF THIRD-PARTY VIDEO CONTENT

(71) Applicant: GOOGLE LLC, Mountain View, CA (US)

(72) Inventors: Ramprasad Sedouram, Bangalore (IN); Daniel V. Klein, Pittsburgh, PA (US)

(21) Appl. No.: 18/072,614

(22) Filed: Nov. 30, 2022

(51) Int. Cl. G06F 16/738; G06F 16/783

(52) U.S. Cl. CPC G06F 16/739; G06F 16/7834; G06F 16/7837

(57) ABSTRACT

An example method includes presenting an item of third-party video content via a user interface, wherein the item of third-party video content is presented prior to presenting an item of primary content or is presented to interrupt the presenting of the item of primary content; providing a user-selectable option associated with an interactive summary of the third-party video content; receiving an indication that the user of the user device has selected the user-selectable option associated with the interactive summary of the third-party video content; and based on receiving the indication that the user of the user device has selected the user-selectable option associated with the interactive summary of the third-party video content: (i) ceasing, by the user device, presentation of the third-party video content, (ii) providing, by the user device, an interactive summary of the third-party video content, and (iii) presenting the item of primary content.

### FIELD OF THE DISCLOSURE

The present disclosure generally relates to providing video content and, more particularly, to providing an interactive summary of third-party video content that may typically be played prior to primary content or otherwise interrupt primary content.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Third-party video content is typically presented prior to the presentation of primary content, or may interrupt primary content, such that the third-party video content must be presented before the primary content begins or continues.

### SUMMARY

In an embodiment, a computer-implemented method for providing an interactive summary of third-party video content that may typically be played prior to primary content or otherwise interrupt primary content is provided. The method may include presenting, by a user device, an item of third-party video content via a user interface, wherein the item of third-party video content is presented prior to presenting an item of primary content or is presented to interrupt the presenting of the item of primary content; providing, by the user device, a user-selectable option associated with an interactive summary of the third-party video content; receiving, by the user device, an indication that the user of the user device has selected the user-selectable option associated with the interactive summary of the third-party video content; and based on receiving the indication that the user of the user device has selected the user-selectable option associated with the interactive summary of the third-party video content: (i) ceasing, by the user device, presentation of the third-party video content, (ii) providing, by the user device, an interactive summary of the third-party video content, and (iii) presenting the item of primary content.

In another embodiment, a system for providing an interactive summary of third-party video content that may typically be played prior to primary content or otherwise interrupt primary content is provided. The system may include one or more processors; and a memory, storing computer-readable instructions that, when executed by the one or more processors, cause the one or more processors to: present an item of third-party video content via a user interface, wherein the item of third-party video content is presented prior to presenting an item of primary content or is presented to interrupt the presenting of the item of primary content; provide a user-selectable option associated with an interactive summary of the third-party video content; receive an indication that the user of the user device has selected the user-selectable option associated with the interactive summary of the third-party video content; and based on receiving the indication that the user of the user device has selected the user-selectable option associated with the interactive summary of the third-party video content: (i) cease presentation of the third-party video content, (ii) provide an interactive summary of the third-party video content, and (iii) present the item of primary content.

In still another embodiment, a non-transitory computer-readable medium storing instructions for providing an interactive summary of third-party video content that may typically be played prior to primary content or otherwise interrupt primary content is provided. The instructions, when executed by one or more processors, may cause the one or more processors to present an item of third-party video content via a user interface, wherein the item of third-party video content is presented prior to presenting an item of primary content or is presented to interrupt the presenting of the item of primary content; provide a user-selectable option associated with an interactive summary of the third-party video content; receive an indication that the user of the user device has selected the user-selectable option associated with the interactive summary of the third-party video content; and based on receiving the indication that the user of the user device has selected the user-selectable option associated with the interactive summary of the third-party video content: (i) cease presentation of the third-party video content, (ii) provide an interactive summary of the third-party video content, and (iii) present the item of primary content.

### BRIEF DESCRIPTION OF THE DRAWINGS

FIG. 1 illustrates a block diagram of an example system that implements techniques of this disclosure in order to provide an interactive summary of third-party video content that may typically be played prior to primary content or otherwise interrupt primary content;

FIG. 2A and FIG. 2B illustrate example displays as may be presented via a user interface of a user device in order to provide an interactive summary of third-party video content that may typically be played prior to primary content or otherwise interrupt primary content; and

FIG. 3 illustrates a flow diagram of an example method for providing an interactive summary of third-party video content that may typically be played prior to primary content or otherwise interrupt primary content, as may be implemented via the system of FIG. 1.

### DETAILED DESCRIPTION

Overview

As discussed above, third-party video content is typically presented prior to the presentation of primary content, or may interrupt primary content, such that the third-party video content must be presented before the primary content begins or continues. However, even users who are interested in particular products or services may not wish to watch third-party video content related to those products or services, or may not wish to delay watching the primary content by the entire runtime of the third-party video content. Currently, it is possible for users to skip the third-party video content immediately or after a pre-determined amount of the third-party video content has been played. However, users who are interested in the particular products or services with which the third-party video content is associated and skip the third-party video content may not learn about offers or other information related to the products or services. Moreover, providers of third-party video content may not be able to distinguish between users who are uninterested in the products or services with which the third-party video content is associated, and users who are uninterested in watching third-party video content generally. Furthermore, presenting third-party video content to users who are uninterested in watching the third-party video content can result in wasted bandwidth.

The present disclosure relates to providing an interactive summary of third-party video content, as an alternative to the current options of playing third-party video content or skipping the third-party video content. In particular, an application that presents primary content to users may present third-party video content at various points with respect to the primary content, and may provide an option, selectable by a user of the application, to cease playing the third-party video content, and instead provide an interactive summary of the third-party video content (or provide the interactive summary of the third-party video content after a predetermined amount of the third-party video content has played). The option to provide the interactive summary of the third-party video content may be used in place of an option to skip the third-party video content, or in combination with an option to skip the third-party video content. Generally speaking, the interactive summary of the third-party video content may include a textual indication of the “gist” of the third-party video content, as well as one or more selectable options to access additional information or other content related to the products or services with which the third-party video content is associated.

Advantageously, bandwidth may be conserved by ceasing playing the third-party video content and instead providing the interactive summary of the third-party video content. Additionally, providers of third-party content may be able to determine which users are interested in the products or services with which the third-party video content is associated, based on whether the users select the options to access additional information or other content related to the products or services with which the third-party video content is associated.

### Example System

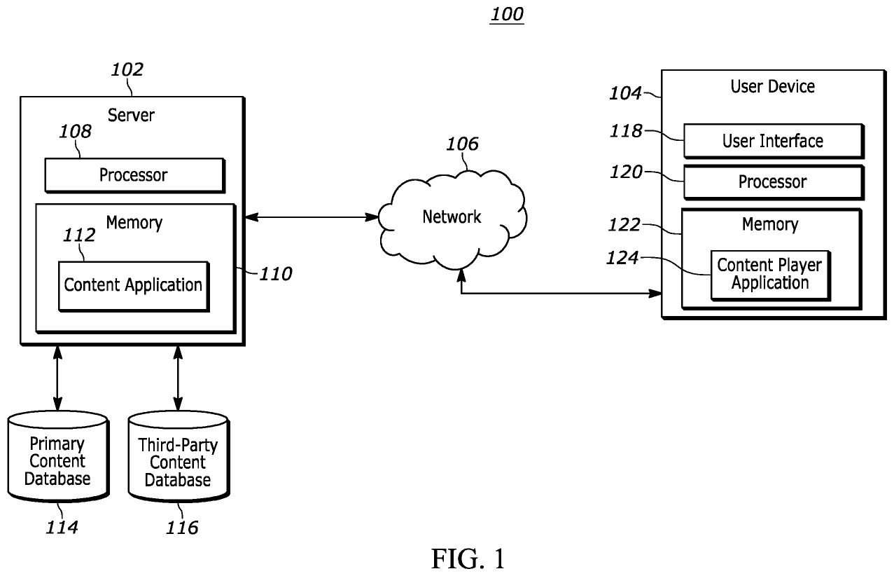

FIG. 1 is a block diagram of a system 100 for providing an interactive summary of third-party video content that may typically be played prior to primary content or otherwise interrupt primary content, in accordance with some examples provided herein. The high-level architecture illustrated in FIG. 1 may include both hardware and software applications, as well as various data communications channels for communicating data between the various hardware and software components, as is described below.

The system 100 may include a server device 102 and a user device 104 (such as, e.g., a smart phone, tablet, smart watch, laptop computer, other personal computer, etc.), configured to communicate with one another, e.g., via a network 106, which may include a wireless network.

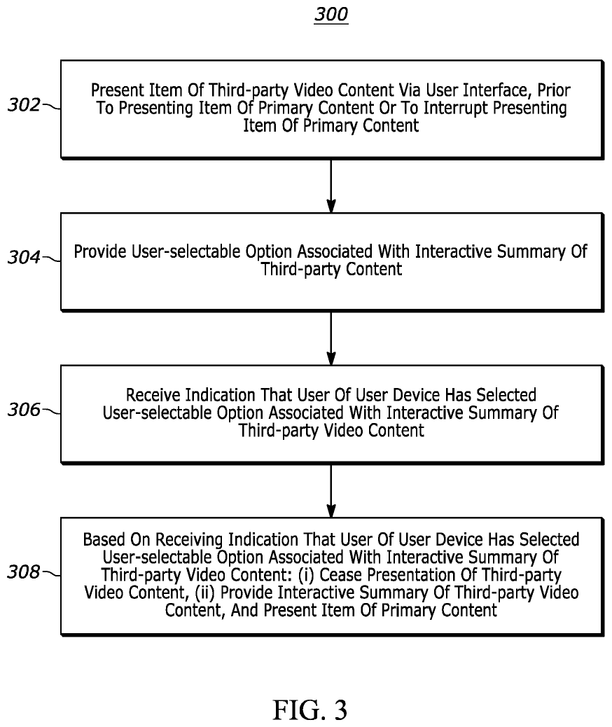

The server device 102 may include one or more processors 108, and a memory 110 (e.g., volatile memory, non-volatile memory). The memory 110 may be accessible by the one or more processors 108 (e.g., via a memory controller). The one or more processors 108 may interact with the memory 110 to obtain, for example, computer-readable instructions stored in the memory 110. The computer-readable instructions stored in the memory 110 may cause the one or more processors 108 to execute one or more applications, including a content application 112. The memory 110 may further store a primary content dataset including primary content, such as primary video content, primary web content, primary game content, etc., and/or a third-party content dataset storing third-party content, including third-party video content, and in some cases, summaries of the third-party video content, and/or may be configured to access a primary content database 114 storing the primary content and/or a third-party content database 116 storing the third-party content. Furthermore, in some examples, the computer-readable instructions stored on the memory 110 may include instructions for carrying out any of the steps of the method 300, described in greater detail below with respect to FIG. 3.

Executing the content application 112 may include accessing the primary content database 114 in order to obtain primary content, and/or otherwise obtaining the primary content. Furthermore, executing the content application 112 may include accessing the third-party content database 116 in order to obtain third-party content, and/or otherwise obtaining the third-party content. In some examples, executing the content application 112 may include analyzing third-party video content in order to generate an interactive summary of the third-party video content, or otherwise obtaining an interactive summary of the third-party video content. The interactive summary of the third-party video content may include a textual indication of the “gist” of the third-party video content. For instance, the third-party video content may be a video advertisement from a particular store, and may visually show products sold in the store using images or videos, visually show discounts available at the store using images or videos, etc., while the interactive summary of the third-party video content may textually identify the store, textually identify the products sold, textually identify the discounts available, etc. For instance, in some cases, executing the content application 112 may include analyzing the third-party video content using a machine learning (ML) or other artificial intelligence (AI) algorithm trained using historical third-party video content and historical summaries of the third-party video content, in order to generate a summary of the third-party video content. Furthermore, in some cases executing the third-party video content may be associated with links to particular web sites or particular applications, and executing the content application 112 may include adding such links to the summary of the third-party video content. Additionally, executing the content application 112 may include sending the primary content, the third-party content, and/or the interactive summary of the third-party video content to the user device 104.

The user device 104 may include a user interface 118, one or more processors 120, and a memory 122 (e.g., volatile memory, non-volatile memory). The memory 122 may be accessible by the one or more processors 120 (e.g., via a memory controller). The one or more processors 120 may interact with the memory 122 to obtain, for example, computer-readable instructions stored in the memory 122. The computer-readable instructions stored in the memory 122 may cause the one or more processors 120 to execute one or more applications, including a content player application 124. Furthermore, in some examples, the computer-readable instructions stored on the memory 122 may include instructions for carrying out any of the steps of the method 300, described in greater detail below with respect to FIG. 3.

Executing the content player application 124 may include receiving the primary content and the third-party content from the server device 102. In some examples, executing the content player application 124 may include receiving the primary content and the third-party content from multiple different server devices. In some cases, the content player application 124 may further receive the interactive summary of the third-party video content as well, while in some cases the content player application 124 may generate the interactive summary of the third-party video content by analyzing the third-party video content, e.g., in a similar manner as discussed above with respect to the content application 112.

Moreover, generally speaking, executing the content player application 124 may include presenting the primary content and the third-party video content, e.g., via the user interface 118. In some examples, the content player application 124 may present an item of third-party video content prior to presenting the primary content, i.e., such that the item of third-party video content must be presented, summarized, or skipped before the content player application 124 will begin presenting the primary content. Furthermore, in some examples, the content player application 124 may present an item of third-party video content in order to interrupt an item of primary content that the content player application is already presenting, i.e., such that the item of third-party video content must be presented, summarized, or skipped before the content player application 124 will resume playing the primary content. Additionally, in some examples, the content player application 124 may present a notification that an item of third-party video content will be presented shortly after the expiration of a period of time (e.g., in 5 seconds, in 3 seconds, etc.) in order to interrupt an item of primary content that the content player application 124 is already presenting, i.e., such that the item of third-party video content must be presented, summarized, or skipped before the content player application 124 will resume playing the primary content.

The content player application 124 may provide (e.g., via the user interface 118) user-selectable options for skipping the third-party video content and/or for providing an interactive summary (e.g., a “gist”) of the third-party video content. In some examples, these user-selectable options may be a single button or selectable user interface element, while in other examples, these user-selectable options may be separate buttons or selectable user interface elements. The content player application 124 may receive an indication that the user-selectable option for providing an interactive summary of the third-party video content has been selected (e.g., by clicking, hovering, etc., via the user interface 118), and may cease (and/or never begin) the presentation of the third-party video content, provide the interactive summary of the third-party video content, and present (e.g., begin or resume) the primary content.

In some examples, the content player application 124 may log which third-party video content was fully presented, which third-party video content was skipped, which interactive summaries were provided for which third party video-content, and/or which links or other interactive elements of the interactive summaries were selected by users, and may send this logged information to the server device 102 for further analysis (e.g., by the content application 112) related to attribution, conversion, etc., associated with the third-party video content.

### Example User Interface Displays

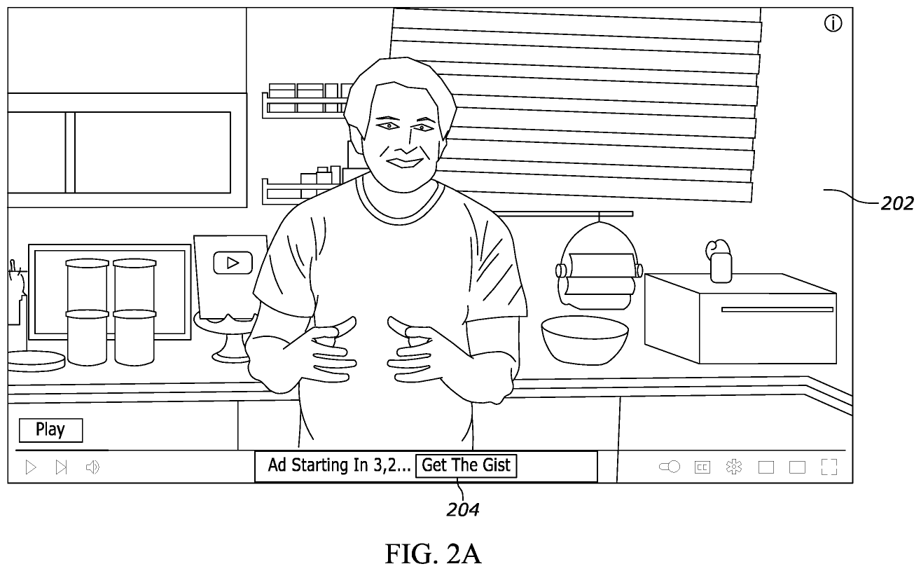

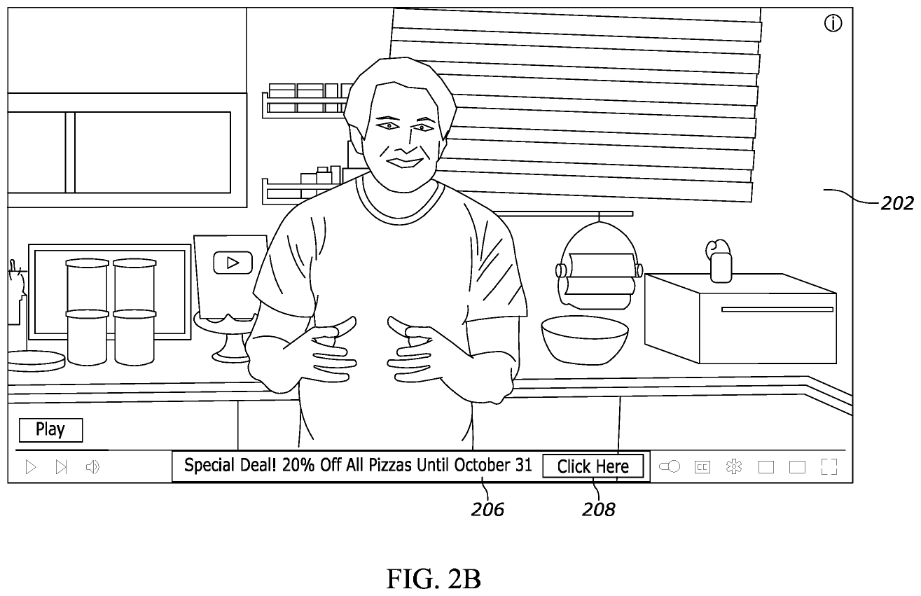

FIG. 2A and FIG. 2B illustrate example displays as may be presented via a user interface 118 of a user device 104 in order to provide an interactive summary of third-party video content that may typically be played prior to primary content or otherwise interrupt primary content.

For instance, FIG. 2A illustrates an item of primary content 202 being presented, e.g., via the user interface 118 of a user device 104. As shown at FIG. 2A, the content player application 124 may present a notification that an item of third-party video content will be presented shortly after the expiration of a period of time (e.g., in 2 seconds, as shown at FIG. 2A) in order to interrupt the item of primary content 202 that the content player application 124 is already presenting, i.e., such that the item of third-party video content must be presented, summarized, or skipped before the content player application 124 will resume playing the primary content 202. Furthermore, as shown at FIG. 2A, the content player application 124 may provide user-selectable options 204 for skipping the third-party video content and/or for providing an interactive summary of the third-party video content. For instance, a skip button and/or a button for providing an interactive summary of the third-party video content may be presented after the third-party video content has been played for a threshold amount of time (e.g., 5 seconds). Additionally, in some examples a button for providing an interactive summary of the third-party video content may be presented after the third-party video content has been played for a threshold amount of time (e.g., 5 seconds), and a skip button may be presented based on the button for providing the interactive summary of the third-party video content being selected.

FIG. 2B illustrates the item of primary content 202, as well as an interactive summary 206 of the third-party video content. As shown at FIG. 2B, the primary content 202 is played while the interactive summary 206 is displayed below the primary content 202, such that a user can view both the primary content 202 and the interactive summary 206 of the third-party video content simultaneously. In some examples, as shown at FIG. 2B, the interactive summary 206 of the third-party video content may include a link 208 related to the interactive summary 206 of the third-party video content.

### Example Method

FIG. 3 is a flow diagram of an example method 300 for providing an interactive summary of third-party video content that may typically be played prior to primary content or otherwise interrupt primary content, as may be used in the system 100 of FIG. 1, in accordance with some examples provided herein. One or more steps of the method 300 may be implemented as a set of instructions stored on a computer-readable memory (e.g., memory 110 of the server device 102, memory 122 of the user device 104, etc.) and executable on one or more processors (e.g., processor 108 of the server device 102, processor 120 of the user device 104).

At block 302, the method 300 may include presenting, (e.g., by a user device, such as the user device 104), an item of third-party video content via a user interface. In particular, the item of third-party video content may be presented prior to presenting an item of primary content, or may be presented to interrupt the presenting of the item of primary content.

At block 304, the method 300 may include providing, by the user device, a user-selectable option associated with an interactive summary of the third-party video content.

At block 306, the method 300 may include receiving, by the user device, an indication that the user of the user device has selected the user-selectable option associated with the interactive summary of the third-party video content.

At block 308, the method 300 may include, based on receiving the indication that the user of the user device has selected the user-selectable option associated with the interactive summary of the third-party video content, (i) ceasing, by the user device, presentation of the third-party video content, (ii) providing, by the user device, an interactive summary of the third-party video content, and (iii) presenting, by the user device, the item of primary content.

In some examples, the interactive summary may be automatically generated (e.g., by the server device 102, or by the user device 104) based on the item of third-party video content. For instance, the interactive summary may be automatically generated based on the server device 102 and/or the user device 104 analyzing one or more of an audio or visual component of the item of third-party video content.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

A hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module in dedicated and permanently configured circuitry or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a Software as a Service (Saas). For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method, comprising:
presenting, by a user device, an item of third-party video content via a user interface, wherein the item of third-party video content is presented prior to presenting an item of primary content or is presented to interrupt the presenting of the item of primary content;
providing, by the user device, a user-selectable option associated with an interactive summary of the third-party video content;
receiving, by the user device, an indication that the user of the user device has selected the user-selectable option associated with the interactive summary of the third-party video content; and
based on receiving the indication that the user of the user device has selected the user-selectable option associated with the interactive summary of the third-party video content:
(i) ceasing, by the user device, presentation of the third-party video content,
(ii) providing, by the user device, an interactive summary of the third-party video content, and
(iii) presenting, by the user device, the item of primary content.

2. The method of claim 1, wherein the interactive summary is automatically generated based on the item of third-party video content.

3. The method of claim 2, wherein the interactive summary is automatically generated based on analyzing one or more of an audio or visual component of the item of third-party video content.

4. The method of claim 1, wherein ceasing the presentation of the third-party video content is further based on the third-party video content having been presented for a threshold period of time.

5. A system, comprising:
one or more processors; and
a memory, storing computer-readable instructions that, when executed by the one or more processors, cause the one or more processors to:
present an item of third-party video content via a user interface, wherein the item of third-party video content is presented prior to presenting an item of primary content or is presented to interrupt the presenting of the item of primary content;
provide a user-selectable option associated with an interactive summary of the third-party video content;
receive an indication that the user of the user device has selected the user-selectable option associated with the interactive summary of the third-party video content; and
based on receiving the indication that the user of the user device has selected the user-selectable option associated with the interactive summary of the third-party video content:
(i) cease presentation of the third-party video content,
(ii) provide an interactive summary of the third-party video content, and
(iii) present the item of primary content.

6. The system of claim 5, wherein the interactive summary is automatically generated based on the item of third-party video content.

7. The system of claim 6, wherein the interactive summary is automatically generated based on analyzing one or more of an audio or visual component of the item of third-party video content.

8. The system of claim 5, wherein ceasing the presentation of the third-party video content is further based on the third-party video content having been presented for a threshold period of time.

9. A non-transitory, computer-readable medium storing instructions that, when executed by the one or more processors, cause the one or more processors to:
present an item of third-party video content via a user interface, wherein the item of third-party video content is presented prior to presenting an item of primary content or is presented to interrupt the presenting of the item of primary content;
provide a user-selectable option associated with an interactive summary of the third-party video content;
receive an indication that the user of the user device has selected the user-selectable option associated with the interactive summary of the third-party video content; and
based on receiving the indication that the user of the user device has selected the user-selectable option associated with the interactive summary of the third-party video content:
(i) cease presentation of the third-party video content,
(ii) provide an interactive summary of the third-party video content, and
(iii) present the item of primary content.

10. The non-transitory computer-readable medium of claim 9, wherein the interactive summary is automatically generated based on the item of third-party video content.

11. The non-transitory computer-readable medium of claim 10, wherein the interactive summary is automatically generated based on analyzing one or more of an audio or visual component of the item of third-party video content.

12. The non-transitory computer-readable medium of claim 9, wherein ceasing the presentation of the third-party video content is further based on the third-party video content having been presented for a threshold period of time.

13.-24. (canceled)

25. The computer-implemented method of claim 2, wherein the interactive summary is automatically generated based on analyzing one or more of an audio or visual component of the item of third-party video content using a machine learning model that is trained to generate an interactive summary of third-party video content using historical third-party video content and historical summaries of the historical third-party video content.

26. The system of claim 6, wherein the interactive summary is automatically generated based on analyzing one or more of an audio or visual component of the item of third-party video content using a machine learning model that is trained to generate an interactive summary of third-party video content using historical third-party video content and historical summaries of the historical third-party video content.

27. The non-transitory computer-readable medium of claim 11, wherein the interactive summary is automatically generated based on analyzing one or more of an audio or visual component of the item of third-party video content using a machine learning model that is trained to generate an interactive summary of third-party video content using historical third-party video content and historical summaries of the historical third-party video content.
